(19) United States
(12) Patent Application Publication
(10) Pub. No.: US 2008/0213531 A1
(43) Pub. Date: Sep. 4, 2008

(54) Method for manufacturing a tufted nonwoven fabric, tufted nonwoven fabric, and use thereof

(75) Inventors: Norbert GOFFING, Neunkirchen (DE); Engelbert LOCHER, Worms (DE); Ararad EMIRZE, Kaiserslautern (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: CARL FREUDENBERG KG, Weinheim (DE)

(21) Appl. No.: 12/029,301

(22) Filed: Feb. 11, 2008

(30) Foreign Application Priority Data
Feb. 12, 2007 (DE) 102007006759.5-26

(51) Int. Cl. B05D 1/16; B32B 33/00

(52) U.S. Cl. 428/90; 156/72

(57) ABSTRACT

The invention relates to a method for the manufacture and use of a tufted nonwoven fabric, wherein fibers for tufts in tuft backing which deviate from a circular fiber cross section are used which exhibit an adhesive force of greater than 40 mN with respect to a tuft yarn, the adhesive force being determined transverse to the longitudinal direction of the fibers. According to the invention, such nonwoven fabrics are used as carpet backing for the manufacture of carpet.

### TECHNICAL FIELD

The invention relates to a method for manufacturing a tufted nonwoven fabric and the use of a nonwoven fabric obtained therefrom, in particular in the form of a carpet backing.

A so-called tufted carpet is manufactured by using tufts or tufting, i.e., a technique for producing three-dimensional surfaces which functions according to the principle of a sewing machine.

In this process, tufting needles introduce a tuft yarn into a base material, the so-called tuft backing. The tufting needles mounted on a needle bar are positioned along the width of the base material, a nonwoven fabric, for example, and simultaneously pierce through the base material. Before the tufting needles return upward to their starting position, the introduced tuft yarn is secured to the underside of the base material by grippers, referred to as loopers. This results in loops or slings, so-called neps, which form the visible side (top layer) of the finished carpet.

Depending on the application, these loops may be cut during the tufting process, using special blades. This results in the velour carpet, which is preferred in particular in the automotive interior sector, where it accounts for more than 95% of the total use.

Frequently used as tuft backing are nonwoven fabrics made of thermoplastic polymers, for example polyethylene terephthalate (PET) fibers and/or polypropylene (PP) fibers, which are bonded by needling, spot welding, by use of a chemical binder, by means of binding fibers, or a combination of these bonding processes.

The use of exclusively spot-welded or exclusively binder-bonded nonwoven fabrics is disadvantageous because these fabrics are not particularly well suited for production of three-dimensional shaped articles due to their poor deformability, especially for use in the automotive field.

When conventional round fibers are used, the contact surface and the friction between the fibers used in the nonwoven fabric tuft backing and the tuft yarns is relatively small, so that the retention force for the tuft yarn, in particular for complex carpet surface structures such as cut-loop velour or looped grades, or crossover velour grades (with offset pile knots), is frequently insufficient. The tuft yarn introduced into the tuft backing after penetration and withdrawal of the tufting needle may lose its intended position, i.e., the height or location of the nep, for example as the result of the combination of slight variations in tuft backing density, yarn tension, and yarn quality, and in some cases the tuft yarn may even be pulled from the tuft backing. In both cases this may result in very noticeable defects and undesirable design flaws in the top layer of the tufted carpet.

The known conventional nonwoven fabrics having round fibers and used as tuft backing therefore do not meet the various requirements for particularly good adhesion of the tufted tuft yarns in the tuft backing, and are not always satisfactory for a defect-free tuft pattern in the top layer of the carpet.

It is known from U.S. Pat. No. 6,740,385 B2 that pattern uniformity and dimensional stability, in particular stability against deformation during and after the tufting process, may be improved by bringing tightly woven fabrics into contact with a uniform nonwoven fabric layer made of staple fibers and fusing them together.

### DESCRIPTION OF THE INVENTION

The object of the invention is to provide a method for manufacturing a tufted nonwoven fabric which, by virtue of the type of fibers used, results in a nonwoven fabric with improved nep adhesion properties, in particular an improved carpet backing. A further object is to greatly simplify the exacting tufting process and to increase the tufting speed. A further object is that the product thus manufactured, in particular the carpet, exhibits improved properties of use.

The object is achieved according to the invention by the features of claim 1. For this purpose, in the method according to the invention for manufacturing a tufted nonwoven fabric, fibers which deviate from a circular fiber cross section are used which exhibit an adhesive force of greater than 40 mN with respect to a tuft yarn, the adhesive force being determined transverse to the longitudinal direction of the fibers.

In this context, fibers are understood to mean staple fibers or continuous fibers, referred to as filaments. The fibers may also be combined to form fleeces, in particular bonded fleeces, for nonwoven fabrics.

The proportion of fibers having a fiber cross section which deviates from a circular cross section is preferably 1 to 99% by weight.

The specific cross-sectional shape of the fibers used plays a secondary role, provided that under the stated conditions a nep adhesive force with respect to a tuft yarn is achieved in the stated range. Fibers having a triangular cross section, referred to as trilobal fibers, fibers having a star shape with four, five, or more arms, or fibers having a flat, oval, T-shaped, M-shaped, S-shaped, Y-shaped, or H-shaped cross section may be used.

The cross sections shown below are provided for illustration.

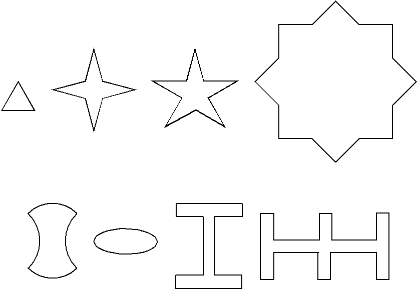

Fibers which contain at least two polymer components are advantageously used in the method for manufacturing the tufted nonwoven fabric.

The fibers used preferably contain the various polymer components in the form of a mixture of monocomponents, multicomponents, or mixtures of these fibers.

When thermal bonding is performed, one polymer component may act as a binding component, the melting temperature of this component preferably being 100 to 155° C. lower than that of the other component.

The proportion of binding components in the fibers or mixture thereof is advantageously 1 to 20% by weight, preferably less than or equal to 10% by weight, particularly preferably less than or equal to 5% by weight, relative to the total weight of the nonwoven fabric. In this manner the mechanical properties of the manufactured nonwoven fabric may be adapted to the particular use.

Furthermore, for the manufacture of the tufted nonwoven fabric, in particular for use as carpet backing, fibers are preferably used which are composed of thermoplastic polymers, in particular polyesters, polyolefins, preferably polyethylene and/or polypropylene, or polyamides, polylactates, and/or copolymers derived therefrom.

With regard to the required strength properties of the nonwoven fabric, fibers are preferably used which have a titer in the range of 5 to 14 dtex (SI unit: 1 dtex=1 g/10,000 m).

The increased fiber-fiber friction results in better dimensional stability of the tuft backing and the tufted carpet backing manufactured therefrom, which is advantageous for all carpet manufacturing processes. The tufting/carpet backing is more dimensionally stable, since on account of increased static friction and sliding friction such fibers adhere to one another better than do round fibers, thereby improving the dimensional stability for all hydrothermal processes.

According to the invention, the tufted nonwoven fabrics manufactured by the method are used as carpet backing for the manufacture of carpet, and the fibers are composed predominantly of polymers such as polyesters and/or polyamides.

The tufted nonwoven fabrics manufactured by the method may also be used as filter media, or as a distributing layer in absorbent sanitary articles.

### EXECUTION OF THE INVENTION

The subject matter of the invention is explained in greater detail with reference to one example, without limiting the invention.

The suitability of the fibers used for manufacturing the tufted nonwoven fabrics is determined in the manner described below.

Various non-round fibers, and as a comparison, a round fiber, are each clamped, a carpet yarn is threaded in and pulled over the fibers, and the resulting tensile force on the yarn is determined by use of a spring scale. Alternatively, a yarn may be clamped and the fiber may be pulled over it.

As yarns for measurement of the retention force or adhesive force, in the carpet industry customary tuft yarns are used, for example BCF yarn (bulked continuous filament, textured continuous yarn) which consists of 64 individual filaments having an individual strength of 19 dtex. The force is measured which occurs in the fiber or yarn when the static friction is overcome and the fiber or yarn begins to slide.

Measurement Technique:

Average values from each of 10 measurements:

| | | | | | | Round |
|---|---|---|---|---|---|---|
| | | M fiber | S fiber | Y fiber | T fiber | fiber |
| Adhesive force, | mN | 56 | 54 | 45 | 50 | 29 |
| tuft yarn over a | | | | | | |
| fiber | | | | | | |

### EXEMPLARY EMBODIMENT

The described filaments or continuous fibers were used to manufacture a nonwoven fabric, described in greater detail below, which is particularly suited for use in the carpet industry.

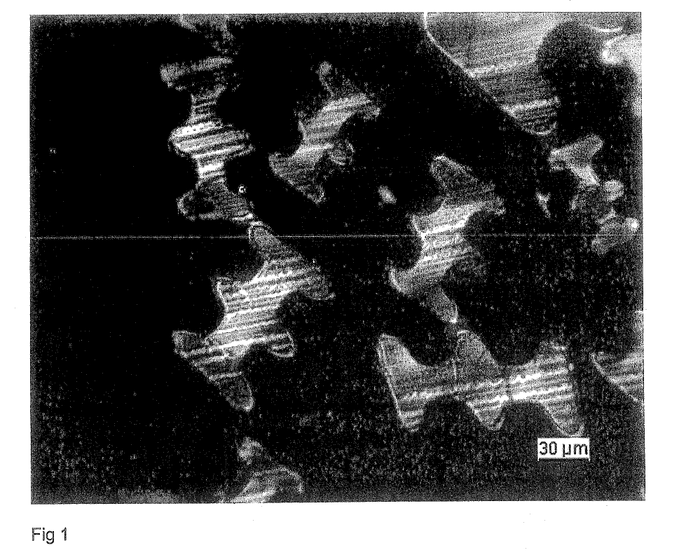

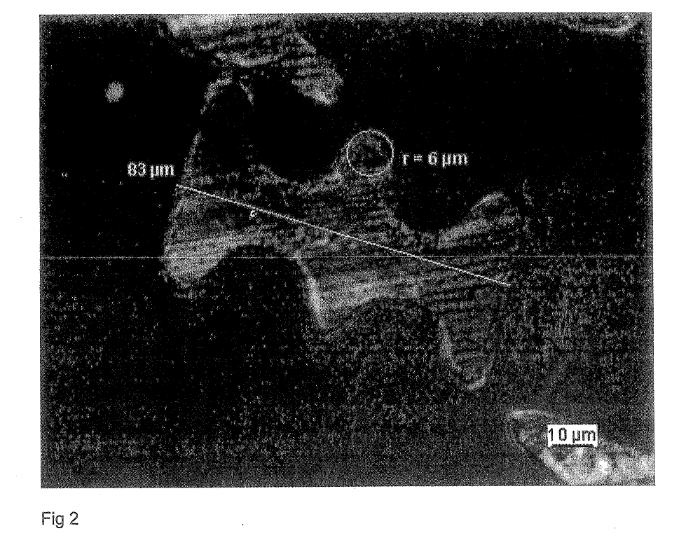

The nonwoven fabric was composed of 90% by weight polyethylene terephthalate (PET) fibers, having approximately M-shaped cross sections as illustrated in FIGS. 1 and 2, which were bonded by a copolyester having a melting temperature approximately 50° C. lower, resulting in improved adhesion due to the noncircular cross section.

The scanning electron micrographs allow the fiber/fleece cross section and the surface structure to be recorded at appropriate magnifications. The scanning electron micrographs were produced using a JEOL JSM-6480LV low-pressure scanning electron microscope at an acceleration voltage of 20 kV.

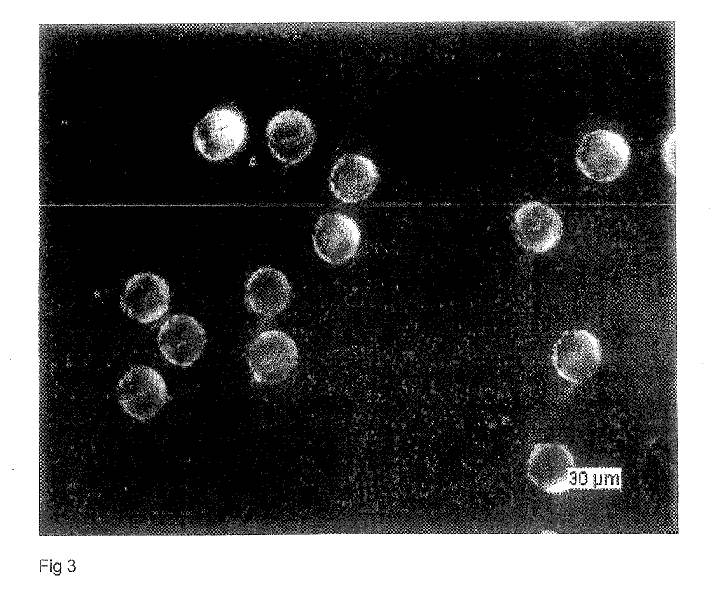

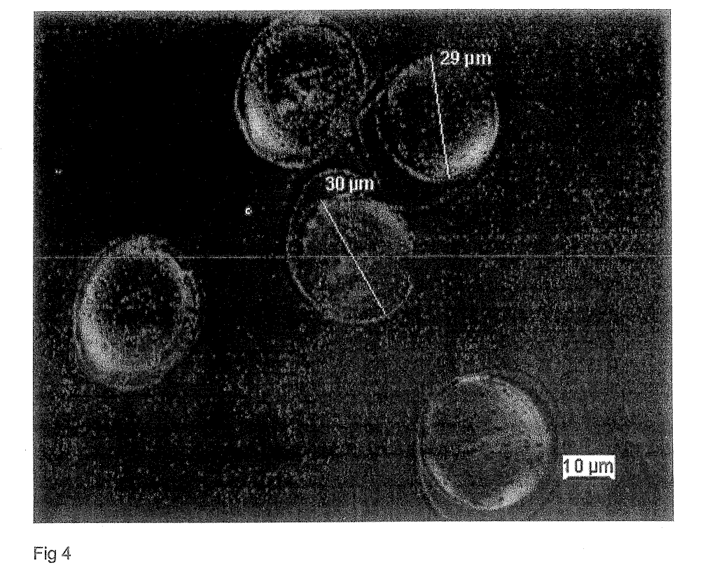

FIGS. 3 and 4 show comparative scanning electron micrographs of fiber cross sections of conventional round PET fibers.

The fiber cross sections of the non-round fibers have a much larger circumference compared to the fiber cross sections of the round fibers, resulting in a correspondingly larger surface of the non-round fibers.

The specific strength of such a non-round fiber spun from a polyester, having an intrinsic solution viscosity of 0.63 to 0.69, was in the range of 25 to 40 cN/tex (SI unit: 1 cN/tex=10⁴ m²/s²). The elongation was between 90 and 150% (DIN 53812 and DIN 53816).

The nonwoven fabric had a weight per unit area of 65 to 180 g/m². The specific initial modulus in the production direction was 0.97 Nm²/g, and at an angle 90° transverse thereto was 1.1 Nm²/g.

A nonwoven fabric manufactured under the same boundary conditions, but composed of round fibers, had an initial modulus of 0.88 Nm²/g in the production direction and 0.79 Nm²/g in the transverse direction. The maximum elongation of such a nonwoven fabric was between 25 and 50% (EN 29073, Part 3).

What is claimed is:

1. Method for manufacturing a tufted nonwoven fabric, wherein fibers for tufts in tuft backing which deviate from a circular fiber cross section are used which exhibit an adhesive force of greater than 40 mN with respect to a tuft yarn, the adhesive force being determined transverse to the longitudinal direction of the fibers.

2. Method according to claim 1, wherein a mixture containing round fibers is used, and the proportion of fibers having a fiber cross section which deviates from a circular cross section is 1 to 99% by weight.

3. Method according to claim 1, wherein the fibers used contain at least two polymer components.

4. Method according to claim 1, wherein the fibers used contain various polymer components in the form of a mixture of monocomponents, multicomponents, or mixtures of these fibers.

5. Method according to claim 3, wherein when thermal bonding is performed, one of the polymer components acts as a binding component, the melting temperature of this component being 100 to 155° C. lower than that of the other component.

6. Method according to claim 5, wherein the proportion of binding component is 1 to 20% by weight, relative to the total weight of the nonwoven fabric.

7. Method according to one of the preceding claims claim 1, wherein the fibers are selected from thermoplastic polymers such as polyesters, polyolefins, polyamides, polylactates, and/or copolymers derived therefrom.

8. Method according to one of the preceding claims claim 1, wherein the fibers have a titer in the range of 5 to 14 dtex.

9. Tufted nonwoven fabric manufactured by a method according to claim 1.

10. Use of a tufted nonwoven fabric according to claim 9 as carpet backing for the manufacture of carpet.

11. Use of a tufted nonwoven fabric according to claim 9 as carpet backing for the manufacture of carpet, wherein the fibers are selected from polyesters and/or polyamides.
